(19) United States
(12) Patent Application Publication
(10) Pub. No.: US 2012/0200088 A1
(43) Pub. Date: Aug. 9, 2012

(54) Sipoline Hydro Electric Generator

(76) Inventor: Aquino Andrian Harris, Paterson, NJ (US)

(21) Appl. No.: 13/020,555

(22) Filed: Feb. 3, 2011

(51) Int. Cl. H02K 7/18; F04D 19/00; F04F 10/00; F03B 17/04

(52) U.S. Cl. 290/52; 137/153; 137/147; 415/220; 415/916

(57) ABSTRACT

A portable hydroelectric generator that carries its own water supply. A tube with a first opening at one end for receiving fluid from a trough and a second opening at the other end for discharging the received fluid. The tube has an inverted U shape having a side A which extends from the first opening toward the top of the inverted U and a side B which includes a turbine coupled to a generator extends from the top of the inverted U to the second end. Side A has a volume which is smaller than the volume of side B and the second opening is located above the level of the fluid in the trough. When fluid is in the tube, its weight in side B is greater than its weight in side A which causes the fluid to flow from the first opening through the tube and out of the second opening.

### BACKGROUND OF THE INVENTION

1. Field of the Invention

The present invention relates generally to electric power generation and, more particularly to a portable hydroelectric power generator that carries its own water supply.

2. Description of Related Art

The use of pressurized fluids such as gas, steam, etc, to rotate a generator is known. As the size of the hydroelectric power generation equipment becomes smaller, the magnitude of electric power produced also becomes smaller. In addition, the amount of flowing water from which kinetic energy may be extracted becomes less. There are many small scale systems that include flowing pressurized liquid and require electric power to operate. Some examples include residential water treatment systems, automatic plumbing fixtures, flow rate monitors, water testing equipment, etc. Hydroelectric power generation in which kinetic energy is extracted from flowing water and used to rotate a generator to produce electric power is known in the prior art. More specifically, by way of example, U.S. Pat. No. 7,471,006 to Janca, et al. discloses a system for generating power using water current. The subsurface power generating system includes a first power generating node with a cross-flow turbine, a universal gear coupled to the cross-flow turbine, a modular generator; and a clutch for engaging and disengaging the modular generator and the universal gear.

U.S. Pat. No. 7,429,803 to Davis discloses a sewer line power generating system designed to be positioned within a manhole. The system generates electricity from water flowing through sewer lines. The system includes a hydro turbine that can be raised and lowered into water flowing through sewer lines.

U.S. Pat. No. 7,319,278 to Gehring discloses a generator mounted to a buoy which floats on the surface of the ocean. Upward movement of the buoy and generator due to a wave causes a cable to unwind from a pulley which turns the generator. A spring connected to the pulley rewinds the cable when the buoy and generator drop into the trough of a wave.

U.S. Pat. No. 7,233,078 to Baarman, et al. discloses a A miniature hydro-power generation system may produce electric power from a flow of liquid. The miniature hydro-power generation system may include a housing that includes a plurality of paddles positioned to extend outwardly from an outer surface of the housing. The system may also include a nozzle and a centering rod extending through the housing. The housing may rotate around the centering rod when a stream of liquid from the nozzle is directed at the paddles. A generator that includes a rotor and a stator may be positioned within a cavity of the housing. The rotor may be coupled with the housing and the stator may be coupled with the centering rod. The rotor may rotate around the stator at high RPM to generate electric power when the housing rotates. The electric power may supply a load and/or may be stored in an energy storage device.

U.S. Pat. No. 7,199,483 to Lomerson, Sr., et al. discloses a tidal power generator which has a floating vessel hull that moves vertically up and down with the tide. Linear-to-rotary converters are coupled between the vessel hull and a fixed object which allow the hull to move vertically while constraining the horizontal movement of the hull. The converters convert the vertical movement of the hull into rotary movement, which is then used to drive an electrical generator.

U.S. Pat. No. 7,042,113 to Aukon discloses a hydroelectric generator having a fixed axle, a transmission axle parallel to the fixed axle, and a transmission system configured to rotate the transmission axle about the fixed axle and to apply a force to a driven member of a device for generating electricity.

U.S. Pat. No. 6,531,788 to Robson discloses a submersible generating plant for producing electricity from ocean currents. The apparatus consists of two counter-rotating, rear-facing turbines with a plurality of rotor blades which extend radially outward from two separate horizontal axis that convey the kinetic energy from the two side-by-side turbine rotors through separate gearboxes to separate generators that are housed in two watertight nacelles that are located sufficiently far apart to provide clearance for the turbine rotors. The two generators and their gearboxes serve as ballast and are located below a streamlined buoyancy tank that extends fore and aft above and between them. A leverage system having no moving parts adjusts lifting forces to balance changing downward vector forces that result from changes in drag acting on a downward angled anchor line.

U.S. Pat. No. 6,359,347 to Wolf discloses generating hydroelectric power from a water source by lifting water from a relatively lower position to a second relatively raised position. The water is moved in a generally upward direction stepwise from a lowermost tier to an uppermost tier in a plurality of stacked tiers. The water from the water source is initially upwardly siphoned to the lowermost tier. The water from the lower tier is then upwardly siphoned to a next adjacent higher tier. The water from the uppermost tier is channeled down to turn a turbine driven generator to produce electrical power.

U.S. Pat. No. 4,746,808 to Kaeser discloses a generator unit driven by a small Pelton turbine having a plurality of injectors each having a single tubular part connected to a ring-shaped distribution chamber. The turbine wheel drives a multiphase synchronous generator having permanent magnets. The water flow rate is regulated at the input of the turbine by means of a regulation valve controlled by an electronic regulation unit, to automatically control the power of the generator unit as a function of the output voltage variations.

U.S. Pat. No. 4,514,977 to Bowen discloses a vacuum pump attached to the top of an enclosed tank situated above a lower liquid level to sequentially draw liquid from the lower level into the tank and thereafter drain the tank to operate a turbine generator.

The term sipoline as used herein refers to a non-fuel, portable hydro-electric generator. It does not require a flowing stream or waterway to initiate or sustain the flowing of water over the turbine system for the generation of electricity. Instead it carries its own internal water moving and recycling mechanism to maintain a continuous flow of water over at least one turbine to generate this electricity. The water moving and recycling process is achieved by the adaptation of a siphon in the system.

A siphon is a hose or tube that allows fluids to be transferred from one area or a container, usually where the height of the liquid contained is higher, to another area that is at a lower level over a hump or elevation. In preparing a siphon to transfer liquids, one end of the hose or tube is located in the fluid to be transferred and air is removed from the tube, usually via the other end. After the tube is filled with the fluid such as water, the other end is placed in the area of desired transfer. Gravitational forces acting on the water surface within the container being transferred through the open ended tube pushes the water through the tube until the levels are even or the end of the submerged tube in the container is no longer in contact with the water.

With sipoline, the siphon is designed in such a way that instead of having bodies of water standing side by side and fluid being transferred from one to the other side, the bodies of fluid are designed to be one above the other. Designing the siphon in this way creates a water cycle that is very much less prone to be broken for the reason of a too low water level where the transferring tube can no longer access the fluid. This design results in whatever water transferred is allowed to fall back down into the container from which it was carried and, therefore, maintain the amount of fluid available and which can be supplied to the siphon on a continuous basis.

### SUMMARY OF THE INVENTION

In an exemplary embodiment of the present invention, there is disclosed a portable hydroelectric generator that carries its own water supply. A tube with a first opening at one end for receiving fluid from a trough and a second opening at the other end for discharging the received fluid into the trough. The tube has an inverted U or semicircular shape having a side A which extends from the first opening toward the top of the inverted U or semicircular shape and a side B which includes a turbine coupled to a generator which extends from the top of the inverted U or semicircular shape to the second end. Side A has a volume which is less than the volume of side B and the second opening is located above the level of the fluid in the trough. When fluid is in the tube, its weight in side B is greater than its weight in side A which causes the fluid to flow from the first opening through the tube and out of the second opening.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a simplified diagram of a sipoline in accordance with the principles of the invention;

FIG. 2 is a front sectional view of the sipoline system in accordance with the principles of the invention;

FIG. 3 is a side view of the sipoline system in accordance with the principles of the invention;

FIG. 4 is a rear view of the sipoline system where an operation control is shown along with an on/off control lever of the sipoline system;

FIG. 5 is a front view of the invention showing electrical sockets adapted to receive a plug connected to an electrical conductor;

FIG. 6 is a view of the back of the control structure that controls the on and off rotation of the turbine;

FIG. 7 is a side sectional view of the invention; and

FIG. 8 is a top sectional view of the invention.

### DESCRIPTION OF THE PREFERRED EMBODIMENT

This invention is an improvement on most of the features which makes pumped storage hydroelectricity unattractive and unfavorable as a source of power. Pumped storage hydroelectricity is employed mainly in areas that have relatively intermittent or weak hydraulic flow from rivers or some kind of natural waterway. In order to maintain strong currents and useful hydraulic pressure which is needed to meet the electricity demand of customers, the tendency is to use energy generated from hydroelectricity to pump water to a man made basin in higher grounds. When needed, water from the basin can flow back down through the turbine system of the hydro generator for the production of electricity. This process greatly takes away from the efficiency of the employment of hydroelectricity. Also additional space and greater expenses must be dedicated to the site and construction of the man-made basin.

With this invention, pumping water to an area of higher potential where it can flow back down and over turbines for the production of electricity is greatly improved and does not take away from the efficiency of the production of electrical power. The need for a site in higher grounds is also eliminated as a result of how the siphon is designed to work within the confines of the invention. That is, the process is carried out inside a container. As a result of these improvements over pumped storage hydroelectricity, hydropower has been made to work within a confined space, is portable, and yet is capable of delivering all the other benefits of hydro powered electricity. In addition, all the benefits of hydro-powered electricity can be had irrespective of access to rivers, streams or water falls.

Hydroelectricity is one of the cleanest forms of energy available. It leaves very little in the way of undesirable impacts on the environment, which is no waste is produced. Large hydroelectric facility constructions, however, tend to require too much useful land. With this invention hydroelectricity can be experienced anywhere away from natural waterways so long as temperature permits. This invention makes hydroelectricity portable under normal circumstances for any electrical generator.

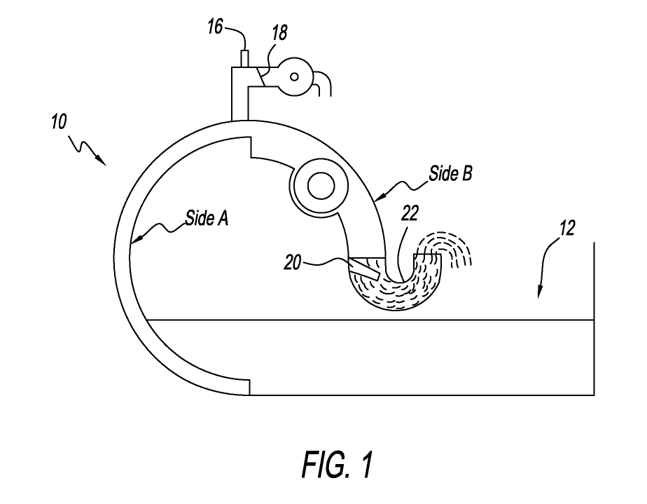

Referring to FIG. 1, there is disclosed a simplified design of a sipoline 10 in accordance with the principles of the invention. It discloses the principles of sipoline that makes it functional for operating a turbine which can be coupled to an electric generator. A trough 12 is filled with water and an air evacuation process which may be permanently attached to the siphon or removably attached to the outlet of the siphon is used to prime the siphon.

In one embodiment where the air evacuation process is permanently attached to the siphon, an air suction device 14 is located at the high point of the siphon and is connected to a sensor 16 which detects the presence of water. When the sensor 16 detects air, it sends a signal to open a first valve 18 and to an air suction device 14 to begin to operate. It also sends a signal to a second valve 20 to seal the outlet of the siphon. As the air in the siphon is sucked out of the siphon, the siphon begins to fill with water from the trough 12. When the siphon is completely filled with water, the sensor will then send a signal to close the first valve and open the second valve. As soon as the two valves are operated, the siphon will begin to operate and water will begin to flow through the siphon.

In another embodiment of the invention the siphon is primed by attaching a suction pump to the outlet end of the siphon and sucking the air out of the siphon until the siphon is filled with water. At this time the suction pump is removed from the siphon and water will begin to flow through the siphon from side A to side B and out through the end of side B to the trough 12. The siphon is constructed to contain a volume of water in side B which is greater than the volume of water in side A. Thus, the weight of the water in side B is greater than the weight of the water in side A, and the water in side B as it flows out of the siphon into the trough will pull water from the trough up side A of the siphon which allows the siphon, which has its outlet end located above its inlet end, to operate.

Repeating, the siphon here disclosed has a side A which has a volume that is less than the volume of side B. Thus, when the siphon is filled with water the weight of the water in side B is greater than the weight of the water in side A and, as the water in side B flows out of the end of the siphon into the trough, water in the trough will be pulled up from the trough into side A of the siphon.

The evacuation of the air causes water in the trough to rise through the siphon, side A. When sides A and B of the siphon are filled with water and the siphon is a closed tube with openings only at its two ends, the fluid in the siphon can be allowed to flow unattended and without interruptions on a continuous cycle provided that none of the fluid is lost or the level of the water in the trough is maintained. To eliminate the possibility that air may enter side B of the siphon while it is operating, a U shaped tube 22 which is filled with water is locate at the end of side B of the siphon. The turbine which is located in side B of the siphon turns under the weight and flow of the fluid flowing out the end of the siphon.

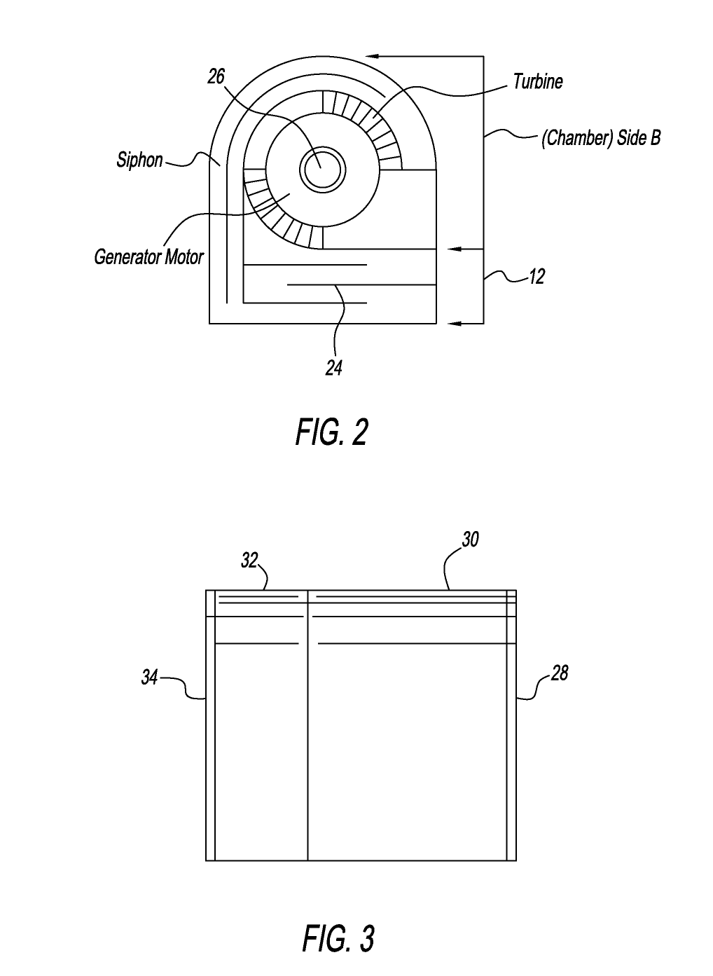

Referring to FIG. 2, there is shown a front sectional view of the sipoline system. In this view, the trough 12, and the chamber which is the large section of side B of the siphon is shown. The chamber forms side B of the siphon and is the end of the siphon designed in the system. The chamber is where the turbine system is located. Fluid collected via the siphon flows into the chamber and upon flowing out into the chamber causes the turbine to spin. The trough is located below the outlet of side B and is a water holding place. Water that is needed by the chamber, side B of the siphon, to flow out to cause rotation in the turbine is pulled up side A of the siphon from the trough. Fluid that has already caused rotation in the turbine system is passed back into the trough. As was stated, the design of the siphon system, of which the chamber, side B of the siphon and the trough maintain a set amount of fluid in the container. A constant amount of water is always available from which the siphon can pull and replenish the chamber. A source of water may be connected to the trough to replenish water in the trough that is lost through evaporation, spray, etc. Fins 24 are located inside the trough which directs the flow of water through it. Their function is to direct the flow of water, control the splash effect of fluid falling from side B of the siphon and ensure efficient operation of the siphon and in extension the generation electricity even in transport that might encounter disturbances such as traveling over rough roads that tend to cause fluids to move around. In this invention the siphon is a tube which has a small diameter at side A and a larger diameter at side B which forms a path that allows fluid to be sucked into the end of the siphon which is located at a low level and be discharged from the end of the siphon which is located at a higher level. The fluid inside the siphon never breaks. Fluid is deposited by the siphon into the chamber. The turbine inside the chamber turns under the weight and pressure of the fluid passing through the chamber back to the trough. A spindle 26 is attached to the turbine and rotates with the fins of the turbine. The spindle forms a part of the rotor for an electric generator

Referring to FIG. 3, there is shown a side view of the sipoline system in accordance with the principles of the invention. The back plate 28 has the control system for the invention that is the on and off switching that controls the rotation of the turbine. The water cycling mechanism 30 contains the hydropower functioning parts of the invention which is more than half the entire length of the system on a whole which ensures a greater rate of rotation for the electrical generator. The generator motor 32 rotates through the driveshaft which forms the rotor for the production of electricity. The front plate 34 contains the electrical circuitry for regulating the amount of electrical power output which is generated as well as electrical sockets for accessing the electrical power produced.

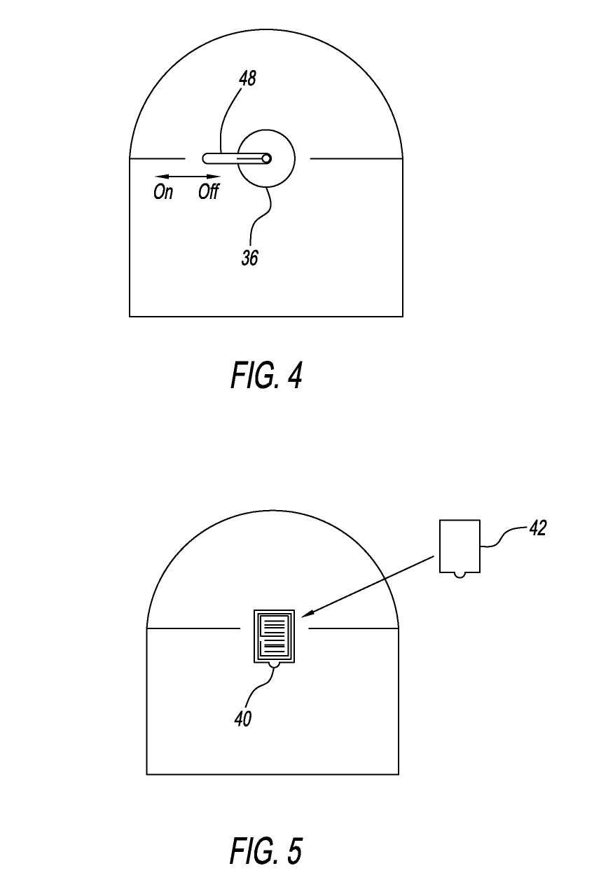

Referring to FIG. 4, there is shown a rear view of the sipoline system where an operation control 48 is shown along with an on/off control lever 38 of the system.

Referring to FIG. 5, there is a front view of the invention showing electrical sockets 40 adapted to receive a plug which is connected to an electrical conductor. The sockets allow for accessing the regulated electrical power generated. This design also includes an electrical socket cover 42 that is used to cover the electrical ports when not in use.

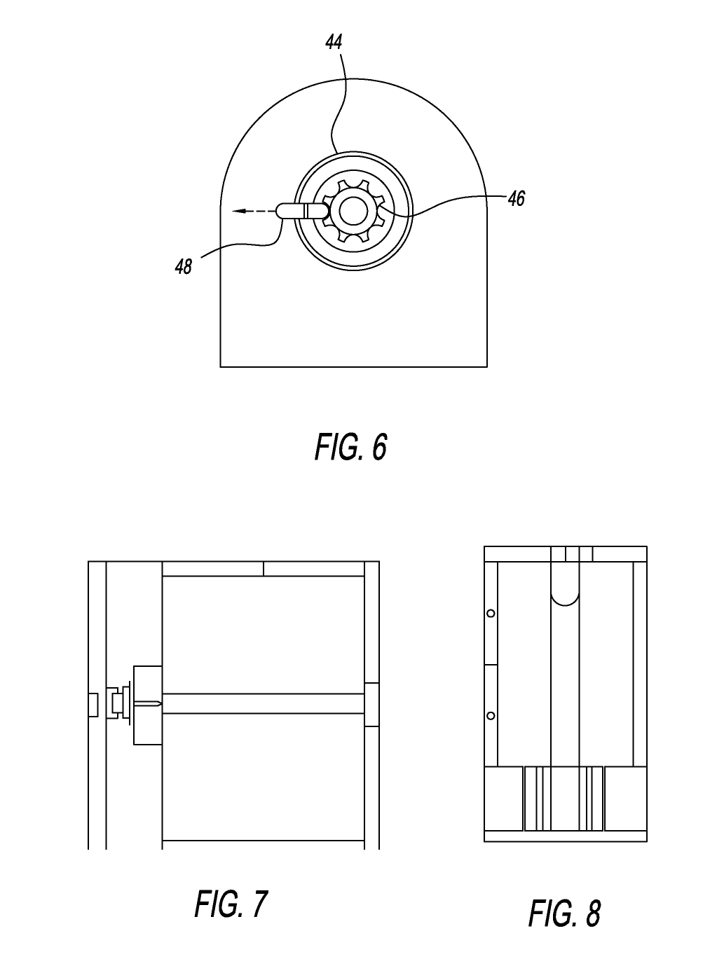

Referring to FIG. 6, there is shown a view of the back of the control structure that controls the on and off rotation of the turbine. A washer 44 locks out contact with the control gear 46 with the chamber and the fluids inside. The control gear turns with the spindle attached to the turbine system. The control slider 48 traverses in and out to engage and disengage the teeth of the control gear that controls the on and off rotation of the turbine.

Referring to FIG. 7, there is shown a side sectional view of the chamber, turbine, control, driveshaft, socket, face plate, generator motor and siphon.

Referring to FIG. 8, there is shown shows a lateral sectional view of the back plate, control, spindle, turbine and driveshaft, generator motor, face plate and siphon.

During manufacture the amount of fluid that is needed to operate the system is determined and the siphon is filled with water by purging it of all air. Preparing the siphon consists of setting the desired amount of fluid in the trough, using an air evacuation process to remove all air from sides A and B of the siphon which results in filling sides A and B of the siphon with water.

To operate the system the control is traversed from the off to the on position which disengages the drive mechanism of the water cycling mechanism (turbine, drive shaft, control gear). Electrical power will begin to be generated and can be accessed by way of the sockets on the front plate. To stop the generation of electricity the control at the back is traversed to the off position, engaging the drive mechanism of the invention that will stop the turbine from rotation and prevent the generator from producing electricity.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A siphon for removing a fluid from a trough comprising:
a tube having a first opening at one end for receiving fluid from the trough and a second opening at the other end for discharging the received fluid;
the tube is configured to form an inverted U or semicircular shape having a side A which extends from the first opening up toward the top of the inverted U or semicircular shape and a side B which extends from the top of the inverted U or semicircular shape to the second end;
side A of the tube has a volume which is smaller than the volume of side B; and
the second opening of the tube is located above the level of the fluid in the trough;
wherein, when fluid is moving through the siphon tube the weight of the fluid in side B of the tube, which is greater than the weight of the fluid in side A, causes the fluid to flow through the tube from the first opening through the tube and out of the second opening.

2. The apparatus of claim 1 wherein, when the tube is filled with fluid, the weight of the fluid in side B is greater than the weight of the fluid in side A.

3. The apparatus of claim 2 wherein a turbine is located within side B of the tube.

4. The apparatus of claim 3 wherein an electrical generator is coupled to the turbine to generate electricity.

5. The apparatus of claim 4 wherein priming means is coupled to the second opening of the tube.

6. The apparatus of claim 4 wherein priming means is coupled to the top of the tube.

7. The apparatus of claim 4 wherein a source of water is coupled to the trough to keep the level of water in the trough substantially constant.

8. The apparatus of claim 4 wherein the second opening faces upward.

9. The apparatus of claim 4 wherein the trough and tube are portable.

10. The apparatus of claim 4 wherein locking means is coupled to selectively prevent the turbine from rotating.

11. The apparatus of claim 2 wherein priming means is coupled to the second opening of the tube.

12. The apparatus of claim 2 wherein priming means is coupled to the top of the tube.

13. The apparatus of claim 2 wherein a source of water is coupled to the trough to keep the level of water in the trough substantially constant.

14. The apparatus of claim 2 wherein the second opening faces upward.

15. The apparatus of claim 2 wherein the trough and tube are portable.
